(19) United States
(12) Patent Application Publication
(10) Pub. No.: US 2021/0165272 A1
(43) Pub. Date: Jun. 3, 2021

(54) Polarizer and Preparation Method Thereof, Display Panel and Display Device

(71) Applicants: BOE Technology Group Co., Ltd., Beijing (CN); Hefei BOE Optoelectronics Technology Co., Ltd., Hefei, Anhui (CN)

(72) Inventor: Zhi Liu, Beijing (CN)

(73) Assignees: BOE Technology Group Co., Ltd., Beijing (CN); Hefei BOE Optoelectronics Technology Co., Ltd., Hefei, Anhui (CN)

(21) Appl. No.: 16/068,438

(22) PCT Filed: Nov. 10, 2017
(86) PCT No.: PCT/CN2017/110376

§ 371 Date: Jul. 6, 2018

(30) Foreign Application Priority Data
May 12, 2017 (CN) 201710333743.4

(51) Int. Cl. G02F 1/1335; G02B 5/30

(52) U.S. Cl. CPC G02F 1/133528; G02F 1/133512; G02B 5/305

(57) ABSTRACT

A polarizer, a preparation method of the polarizer, a display panel and a display device are disclosed. The polarizer includes a polarizing layer which includes a plurality of independent polarizing units. A length of each of the polarizing units is m time or times a length of each of the pixel units, and a width of each of the polarizing units is n time or times a width of each of the pixel units; both m and n are positive integers, and both m and n are not more than 15.

### TECHNICAL FIELD

Embodiments of the present disclosure relate to a polarizer, a preparation method of the polarizer, a display panel and a display device.

### BACKGROUND

The full name of a polarizer is a plate for polarized light, and the polarizer can control the polarization direction of a specific light beam. When natural light passes through a polarizer, light with the vibration direction, which is perpendicular to the transmission axis of the polarizer, is absorbed, and only polarized light with the vibration direction, which is parallel to the transmission axis of the polarizer, passes through the polarizer.

Generally, a polarizer is arranged on the surface of a liquid crystal display panel, for example, the liquid crystal display panel includes two polarizers being respectively arranged at two sides of a base substrate, in which a lower polarizer is used to convert light beams produced by a back light source into polarized light, and an upper polarizer is used to analyze the polarized light being modulated by liquid crystals, so as to result contrast in brightness, and thus a display image is produced.

### SUMMARY

At least one embodiment of the present disclosure provides a polarizer, and the polarizer includes: a polarizing layer which includes a plurality of independent polarizing units.

For example, in the polarizer provided by at least one embodiment of the present disclosure, the polarizer is applied into a display panel, and the display panel includes a plurality of pixel units, and a length of each of the polarizing units is m time or times a length of each of the pixel units, and a width of the each of the polarizing units is n time or times a width of the each of the pixel units; both m and n are positive integers, and both m and n are not more than 15.

For example, in the polarizer provided by at least one embodiment of the present disclosure, both m and n are equal to 1, and the plurality of polarizing units are used to cover the plurality of pixel units in one-to-one correspondence.

For example, in the polarizer provided by at least one embodiment of the present disclosure, a width of each of the polarizing units is not greater than 500 μm and a length of each of the polarizing units is not greater than 1500 μm.

For example, the polarizer provided by at least one embodiment of the present disclosure further includes a protection layer; in which the polarizer is arranged on a first surface of the protection layer.

For example, the polarizer provided by at least one embodiment of the present disclosure further includes a connection layer provided on a second surface of the protection layer.

For example, the polarizer provided by at least one embodiment of the present disclosure further includes a release layer provided on a surface, which is away from the protection layer, of the connection layer.

For example, the polarizer provided by at least one embodiment of the present disclosure further includes an anti-scratch layer provided on a surface, which is away from the protection layer, of the polarizing layer.

For example, in the polarizer provided by at least one embodiment of the present disclosure, a material of the polarizing layer is polyethylene.

For example, in the polarizer provided by at least one embodiment of the present disclosure, a material of the protection layer is cellulose triacetate.

For example, in the polarizer provided by at least one embodiment of the present disclosure, a material of the connection layer is a pressure-sensitive adhesive, the release layer is a release film, and the anti-scratch layer is an anti-scratch film.

At least one embodiment of the present disclosure provides a display panel, and the display panel includes a panel body and any one of the above-mentioned polarizers; in which the polarizer is provided on a first panel surface of the panel body.

For example, in the display panel provided by at least one embodiment of the present disclosure, an edge of each of the polarizing units is corresponds to an outer edge of a black matrix region of a pixel unit, which is covered by the each of the polarizing units, of the panel body.

For example, in the display panel provided by at least one embodiment of the present disclosure, the display panel comprises a plurality of pixel units, and each of the polarizing units covers more than one pixel unit.

For example, in the display panel provided by at least one embodiment of the present disclosure, the display panel comprises a plurality of pixel units; the plurality of polarizing units cover the plurality of pixel units in one-to-one correspondence; and edges of the plurality of polarizing units are located at outer edges of the black matrix regions of the plurality of pixel units in one-to-one correspondence.

At least one embodiment of the present disclosure provides a display device, and the display device includes the display panel described in any one of the above-mentioned embodiments.

At least one embodiment of the present disclosure provides a preparation method of a polarizer, and the preparation method includes cutting a polarizing layer to form a plurality of independent polarizing units.

For example, in the preparation method of the polarizer provided by at least one embodiment of the present disclosure, the polarizer is applied into a display panel, and the display panel comprises a plurality of pixel units, and a length of each of the polarizing units is m time or times a length of each of the pixel units, and a width of the each of the polarizing units is n time or times a width of the each of the pixel units; both m and n are positive integers, and both m and n are not more than 15.

For example, in the preparation method of the polarizer provided by at least one embodiment of the present disclosure, the polarizing layer is formed on a protection layer, and then the plurality of independent polarizing units are formed by cutting the polarizing layer formed on the protection layer.

For example, in the preparation method of the polarizer provided by at least one embodiment of the present disclosure, the polarizing units are in one-to-one correspondence with the plurality of pixel units.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a structural schematic bottom view of a polarizer provided by an embodiment of the present disclosure;

FIG. 2 is a structural schematic front view of the polarizer illustrated in FIG. 1;

FIG. 3 is a structural schematic diagram of a pixel unit in an embodiment of the present disclosure;

FIG. 4 is a structural schematic diagram illustrating a polarizing unit attached to a pixel unit, in an embodiment of the present disclosure;

FIG. 5 is a structural schematic diagram illustrating a polarizing unit attached to a pixel unit, in another embodiment of the present disclosure;

FIG. 6 is a schematic diagram of a display panel in an embodiment of the present disclosure; and

FIG. 7 is a schematic diagram of a display device in an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment (s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

A polarizer generally includes structures such as a polarizing layer, a protection layer, a pressure-sensitive adhesive, a release film, and the like, in which the polarizing layer has a function of polarization. In order to protect the physical characteristics of the polarizing layer, for example, a protection layer, with a high light transmittance, good water resistance and a certain mechanical strength, can be arranged on one side or both sides of the polarizing layer to protect the polarizing layer.

It is found by the inventor of the present disclosure during research that in the environment with high temperature, the polarizer tends to shrink along an extension direction (the direction along an absorption axis) of the polarizing layer. For example, in the case that the polarizer is placed in a high temperature environment with 80° C. for 80 hours, the shrinkage rate of the polarizer is, for example, equal to or less than 5%. In the case that the size of the polarizer is 100 mm, the shrinkage value of the polarizer can reach, for example, 5 mm. In order to prevent edges of the polarizer from shrinking into the display region of a display panel, the width of a bezel at a side of the display panel can be greater than 2.5 mm, this causes narrow bezel designs with the bezel width being less than 2 mm cannot be realized for large-size display panels, such as large-size LCD panels.

For the above-mentioned problem, the shrinkage rate of the polarizer can be reduced to a certain extent by reducing the thickness of the polarizing layer (for example, the thickness of the polarizing layer is reduced by about 2%). In the case where the size of the liquid crystal display panel is greater than 10 inch and the size of the polarizer is about 200 mm, the shrinkage value of polarizing layer is still large even when a thin polarizing layer is adopted; this makes the liquid crystal display panel unable to achieve the narrow bezel design with the bezel width being less than 2 mm.

A polarizer, a preparation method of the polarizer, a display panel and a display device are described below in combination with the accompanying drawings.

### First Embodiment

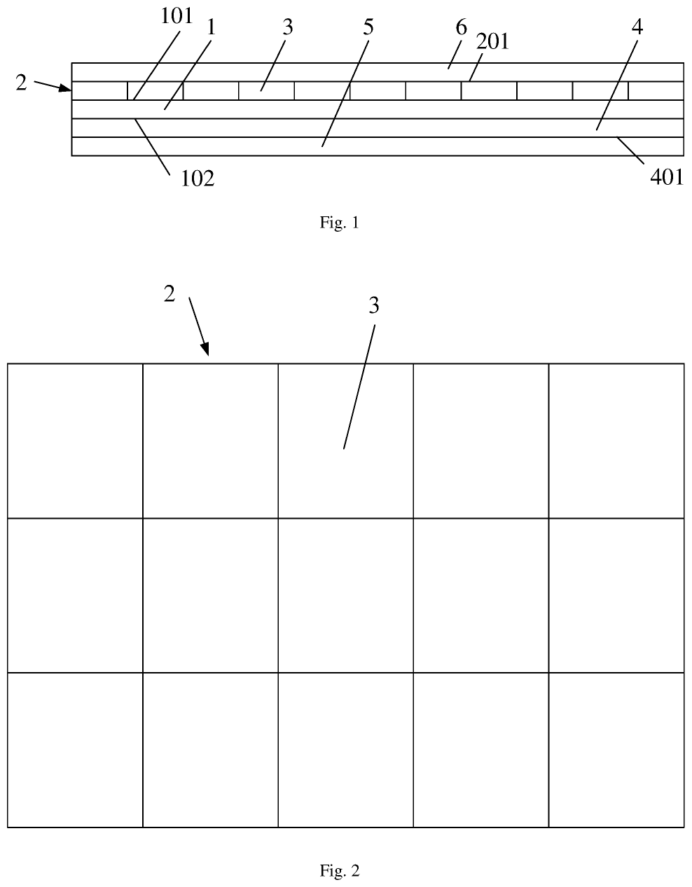

The present embodiment provides a polarizer, as illustrated in FIG. 1 and FIG. 2, the polarizer includes a polarizing layer 2, and the polarizing layer 2 includes a plurality of independent polarizing units 3.

For example, the polarizer can be applied into a display panel, and the display panel includes a plurality of pixel units, and a length of each of the polarizing units 3 is m time or times a length of each of the pixel units, and a width of each of the polarizing units 3 is n time or times a width of each of the pixel units; both m and n are positive integers, and both m and n are not more than 15.

For example, m can be equal to 1, 3, 6, 9, 12 or 15; for example, n can be equal to 1, 3, 6, 9, 12 or 15. In the case that the display panel includes pixel units for a plurality of colors, for example, in the case that the display panel includes three kinds of pixel units, such as red pixel units, green pixel units and blue pixel units, and a group of pixel units includes one of the red pixel units, one of the green pixel units, and one of the blue pixel units, for example, one of the polarizing units 3 can correspond to one or more groups of pixel units, to allow the division of the polarizing units 3 to be more clear and to enable subsequent shrinkage of the polarizing units 3, which is potentially existed, to be allocated to the pixel units for different colors more evenly, so as to alleviate the adverse impact of shrinkage on the display effect of the display panel.

In the present embodiment, as illustrated in FIG. 1 and FIG. 2, for example, the polarizer can further include a protection layer 1, and the polarizing layer 2 is arranged on a first surface 101 of the protection layer 1; the polarizing layer 2 on the protection layer 1 is cut into the plurality of independent polarizing units 3, and the length of each of the polarizing units 3 is m time or times the length of the pixel unit 7, and the width of each of the polarizing units 3 is n time or times the width of the pixel unit 7.

For the polarizing layer 2 provided by an embodiment of the present disclosure, the polarizing layer 2 included by the polarizer is cut into the plurality of independent polarizing units 3, and the shrinkage value of different polarizing units 3 does not affected by each other; the shrinkage value of the entire structure of the polarizing layer 2 is divided into a plurality of portions and the shrinkage value of each of the polarizing units 3 is small. In the case that the polarizer is applied into a display panel, an edge of the polarizing unit 3 can correspond to, for example, a black matrix (BM) region 9, which is used as a light-blocking region of the pixel unit 7, so that the edges of the polarizing unit 3 cannot leave from the black matrix region 9 of the pixel unit 7 into a display region 8 of the pixel unit 7 after the polarizing unit 3 is shrunk, and thus the normal display of the display panel cannot be adversely affected.

The polarizer provided by the embodiments of the present disclosure can be applied into any display panels with a polarizer, such as a liquid crystal display panel, an OLED display panel, and the like. For example, in the case that the polarizer provided by at least one embodiment of the present disclosure is applied into a liquid crystal display panel, the shrinkage value of the polarizing units 3, which are located at the bezel region of the liquid crystal display panel can be significantly reduced, and therefore the bezel of the liquid crystal display panel can be manufactured into a narrow bezel with width being less than 2 mm.

In the present embodiment, in the case that the polarizer provided by at least one embodiment of the disclosure is applied into a display panel, because of a possible presence of cut errors in cutting of the polarizing layer 2, it can be considered that the width of the polarizing unit 3 is n time or times the width of the pixel unit 7 and the length of the polarizing unit 3 is m time or times the length of the pixel unit 7, in the present disclosure, as long as the edge of the polarizing unit 3 is, for example, within the black matrix region 9 of the pixel unit 7, which is covered by the above-mentioned polarizing unit 3.

In the present embodiment, the black matrix region 9, which is provided between adjacent pixel units 7 in the display panel and is shared by the adjacent pixel units 7, can be reasonably allocated to the adjacent pixel units 7, and the black matrix region 9 can be shared equally or unequally by the adjacent pixel units 7. For example, the allocation of the black matrix region can be determined according to the position of the edge of a corresponding polarizing unit 3 covering the black matrix region 9.

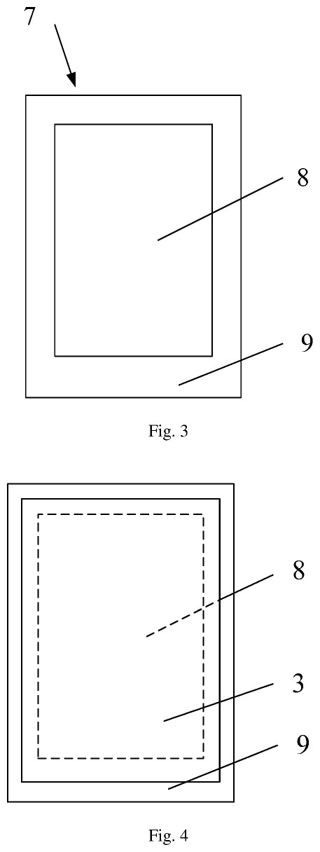

In one example of the present embodiment, as illustrated in FIG. 3 and FIG. 4, both m and n are equal to 1, and the plurality of polarizing units 3 are used to cover the plurality of pixel units 7 in one-to-one correspondence, this reduces the shrinkage value of each of the polarizing units 3 in the case that the subsequent shrinkage potentially existed is occurred.

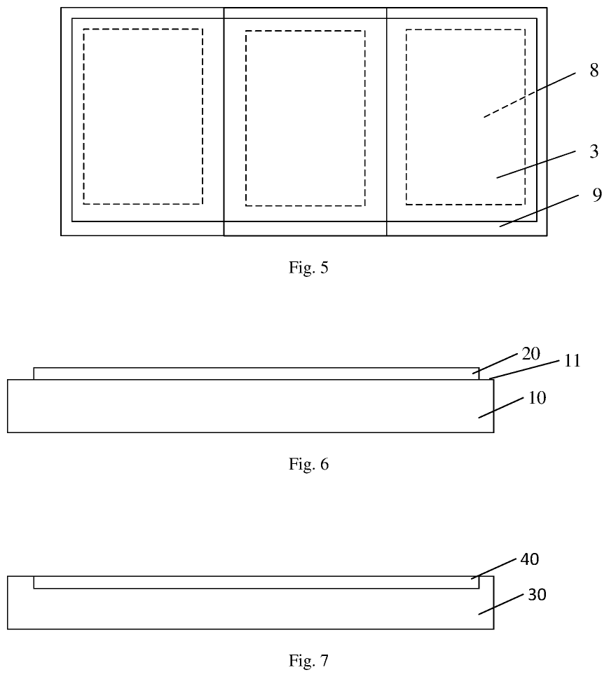

In another example of the present embodiment, as illustrated in FIG. 5, for example, one of the polarizing units 3 can also cover a plurality of pixel units 7. FIG. 5 illustrates the case that one of the polarizing units 3 covers three of the pixel units 7, and in this case, a cutting position used for cutting the polarized units 3, for example, can be determined by calculations, no further descriptions will be given here. In the example illustrated in FIG. 5, the number of times for cutting the polarizing layer in a preparation process of the polarizer can be reduced by allowing one of the polarizing units to correspond to a plurality of pixel units, and thus the preparation process of the polarizer is simplified.

In the present embodiment, the width of the polarizing unit 3 is not greater than 500 μm and the length of the polarizing unit 3 is not greater than 1500 μm, thus the edge of the polarizing unit 3 cannot move into the display region 8 of the corresponding pixel unit 7.

In the present embodiment, as illustrated in FIG. 1, the polarizer can further include a connection layer 4, and the connection layer 4 is provided on a second surface 102 of the protection layer 1 and is used for bonding and fixing the polarizer in the case that the polarizer is applied into the display panel.

In the present embodiment, as illustrated in FIG. 1, the polarizer can further include a release layer 5, and the release layer 5 is provided on a surface 401, which is away from the protection layer 1, of the connection layer 4. When using the polarizer, for example, the release layer 5 can be removed so that the polarizer can be bonded and fixed by the connection layer 4.

In the present embodiment, as illustrated in FIG. 1, the polarizer can further include an anti-scratch layer 6, and the anti-scratch layer 6 is provided on a surface 201, which is away from the protection layer 1, of the polarizing layer 2, so as to prevent the surface 201, which is away from the protection layer 1, of the polarizing layer 2, from being scratched during the delivery and installation of the polarizer.

In the present embodiment, for example, a material of the protection layer 1 can be cellulose triacetate or an equivalent material of cellulose triacetate; for example, a material of the polarizing layer 2 can be polyethylene or an equivalent material of polyethylene; for example, a material of the connection layer 4 can be a pressure-sensitive adhesive or an equivalent material of the pressure-sensitive adhesive; for example, the release layer 5 can be a release film or the like; for example, the anti-scratch layer 6 can be an anti-scratch film or the like.

### Second Embodiment

The present embodiment provides a display panel, and as illustrated in FIG. 6, the display panel includes a panel body 10 and any one of the polarizers 20 provided by the embodiments of the present disclosure; and the polarizer 20 is provided on a first panel surface 11 of the panel body 10.

In the present embodiment, with reference to FIG. 3 and FIG. 4, for example, the edge of the polarizing unit 3 is corresponds to the outer edge of the black matrix region 9 of the pixel unit 7, which is covered by this polarizing unit 3, of the panel body 10.

In the present embodiment, for example, the position of the outer edge of the black matrix region 9 of the pixel unit 7, which is covered by a corresponding polarizing unit 3, can be determined according to the position of the edge of the corresponding polarizing unit 3. For example, the position of the outer edge of the black matrix region 9 of the pixel unit 7, which is covered by the corresponding polarizing unit 3, can be a central position or a non-central position of the black matrix region 9, which is provided between two adjacent pixel units 7.

In the present embodiment, the black matrix regions 9 of adjacent pixel units 7, for example, can be connected together and can be formed in same one preparation process.

In the present embodiment, for example, the display panel can include a plurality of pixel units 7, and the plurality of polarizing units 3 cover the plurality of pixel units 7 in one-to-one correspondence. For example, the edges of the polarizing units 3 can be respectively located at the outer edges of the black matrix regions 9 of the pixel units 7 in one-to-one correspondence, so as to prevent the edges of the polarizing units 3 from being within the display regions 8 of the pixel unit 7 with better effect, and thus the display panel can possess a better display effect.

In the present embodiment, the size of the pixel unit 7 of the display panel can be in the range of 16-100 μm, in this case, for example, the polarizing layer 2 can be cut according to the size of the pixel unit 7 or according to the value of the multiple of the size of the pixel unit 7. Taking the case that the width of the pixel unit 7 is 100 μm and the length of the pixel unit 7 is 300 μm as an example, for example, the polarizing layer 2 is cut according to the size of the pixel unit 7, that is, the polarizing layer 2 is cut into the polarizing units 3 according to the width of 100 μm and the length of 300 μm, the width of the obtained polarizing unit 3 is 100 μm and the length of the obtained polarizing unit 3 is 300 μm. In the case that the high-temperature shrinkage rate of the polarizing unit 3 is 3%, the high-temperature shrinkage value in the width direction and length direction of the polarizing unit 3 are respectively 3 μm and 9 μm. However, the width of the black matrix region 9 at a left portion of the pixel unit 7, the width of the black matrix region 9 at a right portion of the pixel unit 7, and the width of the black matrix region 9 at an upper portion of the pixel unit 7 are not less than 2.5 μm, and therefore, the width of the black matrix region 9, which is disposed between the pixel unit 7 and another pixel unit 7 adjacent to and provided at the left side, the right side and the upper side of the pixel unit 7, is not less than 5 μm, however the shrinkage value of the polarizer in the width direction of the polarizing unit 3 is 3 μm, which is less than 5 μm; in addition, the width of the black matrix region 9 at the lower region of the pixel unit 7 is not less than 5 μm, and therefore, the width of the black matrix region 9, which is disposed between the pixel unit 7 and another pixel unit 7 adjacent to and provided at the lower side of the pixel unit 7, is not less than 10 μm, because the shrinkage value of the polarizer in the length direction of the polarizing unit 3 is 9 μm, which is less than 10 μm, and therefore, the polarizing unit 3 cannot move into the visible region of the corresponding pixel unit 7 under high temperature, and thus the display effect of the display panel cannot be adversely affected (referring to FIG. 4).

In the present embodiment, for example, the cutting size of the polarizing unit 3 is in micrometer scale, and for example, a cutting process of high precision can be performed (such as nano cutting process); in addition, for example, a high precision device can be used to attach the polarizer to a glass substrate of the display panel, so that the position of the edge of the polarizing unit 3 is corresponds to the center of the black matrix region 9 (the center of the black matrix region 9 between two adjacent pixel units 7).

In the present embodiment, the pixel units 7 can have more than one size value, for example, the sizes of different pixel units of the display panel can be the same or be different.

The display panel provided by the present embodiment, for example, can be a liquid crystal display panel, an OLED display panel, and the like. For example, in the case that the display panel is a liquid crystal display panel, the shrinkage value of the polarizing units 3 at the bezel region of the liquid crystal display panel can be significantly reduced, and therefore the bezel of the liquid crystal display panel can be manufactured into a narrow bezel with width being less than 2 mm.

### Third Embodiment

The present embodiment provides a display device. As illustrated in FIG. 7, the display device 30 includes any one of the display panel 40 provided by the embodiments of the present disclosure.

The display panel provided by the present embodiment, for example, can be a liquid crystal display device, an OLED display device, and the like, and the display device 30 possess all the advantages of the display panel 40, no further description will be given here.

### Fourth Embodiment

The present embodiment provides a preparation method of a polarizer, and the method includes: cutting a polarizing layer to form a plurality of independent polarizing units.

For example, the polarizer can be applied into a display panel, and the display panel includes a plurality of pixel units, and a length of each of the polarizing units is m time or times a length of each of the pixel units, and a width of each of the polarizing units is n time or times a width of each of the pixel units; both m and n are positive integers, and both m and n are not more than 15.

In the present embodiment, the polarizing layer can be cut to allow the polarizing units to be in one-to-one correspondence with the plurality of pixel units, this enables the shrinkage value of each of the polarizing units 3 to be small when each of the polarizing units 3 shrinks later; or, the polarizing layer can be cut to allow one polarizing unit is corresponds to a plurality of pixel units, such that the number of times for the cutting process is reduced and the preparation process of the polarizer is simplified.

In the present embodiment, the preparation method of the polarizer can further include: forming a protection layer, in which the polarizing layer is formed on the protection layer, and then the plurality of independent polarizing units are formed by cutting the polarizing layer provided on the protection layer, in which the length of each of the polarizing units is m time or times the length of each of the pixel units, and the width of each of the polarizing units is n time or times the width of each of the pixel units.

For the polarizer formed by the preparation method provided by the embodiments of the present disclosure, for example, as illustrated in FIGS. 1-4, the polarizing layer 2 is cut into the plurality of independent polarizing units 3, and the shrinkage value of different polarizing units 3 does not affected by each other, the shrinkage value of the entire structure of the polarizing layer 2 is equally allocated to the plurality of independent polarizing units 3, so that the shrinkage value of the entire structure of the polarizing layer 2 is divided into a plurality of portions and the shrinkage value of each of the polarizing units 3 is small. In the case that the polarizer is applied into a display panel, the edge of each of the polarizing units 3 can correspond to the black matrix region 9 of one of the pixel units 7, so that each of the polarizing units 3 cannot leave from the black matrix region 9 of the pixel unit 7 into the display region 8 of the pixel unit 7 after each of the polarizing units 3 shrinks, and thus the normal display of the display panel cannot be adversely affected.

In the present embodiment, when the polarizing layer on the protection layer is cut to form the plurality of independent polarizing units, the length of each of the polarizing units is m time or times the length of each of the pixel units, and for example, the length of each of the polarizing units can be not greater than 1500 μm, and the width of each of the polarizing units is n time or times the width of each of the pixel units, and for example, the width of each of the polarizing units can be not greater than 500 μm, so that the edges of each of the polarizing units is within the black matrix region 9 of one of the pixel units 7 after each of the polarizing units shrinks.

In the present embodiment, for example, the cutting size of the polarizing unit 3 is in micrometer scale, and for example, a cutting process of high precision can be performed (such as nano cutting process); in addition, for example, a high precision device can be used to attach the polarizer to a glass substrate of the display panel, so that the position of the edge of each of the polarizing units 3 corresponds to the center of the black matrix region 9 (the center of the black matrix region 9 between two adjacent pixel units 7).

In the present embodiment, for example, a connection layer 4, a release layer 5 and an anti-scratch layer 6 can be formed after the cutting process of the polarizing layer is finished.

In the present embodiment, for example, a material of the protection layer 1 can be cellulose triacetate or an equivalent material of cellulose triacetate; for example, a material of the polarizing layer 2 can be polyethylene or an equivalent material of polyethylene; for example, a material of the connection layer 4 can be a pressure-sensitive adhesive or an equivalent material of the pressure-sensitive adhesive; for example, the release layer 5 can be a release film or the like; for example, the anti-scratch layer 6 can be an anti-scratch film or the like.

In the present embodiment, an edge, which is parallel to a gate line of the display panel, of each of the pixel units is an edge, along the width direction, of each of the pixel units 7 (the length of the edge, along the width direction, is equal to the width of the pixel unit 7); an edge, which is parallel to a data line of the display panel, of each of the pixel units is an edge, along the length direction, of each of the pixel units 7 (the length of the edge, along the length direction, is equal to the length of the pixel unit 7). Or alternatively, the edge, which is parallel to the gate line of the display panel, of each of the pixel units, is an edge, along the length direction, of each of the pixel units 7 (the length of the edge, along the length direction, is the length of the pixel unit 7), and the edge, which is parallel to the data line of the display panel, of each of the pixel units, is the edge, along the width direction, of each of the pixel units 7 (the length of the edge, along the width direction, is the length of the pixel unit 7).

In the present embodiment, for example, every three of the pixel units 7 of the display panel can form one pixel, and for example, the three of the pixel units 7 respectively can be the pixel units for three different colors, for example, pixel units for red, green and blue. In the present embodiment, one of the polarizing units 3 can correspond to one or more pixels.

The polarizer provided by the embodiments of the present disclosure, the polarizing layer is cut into the plurality of independent polarizing units, and the shrinkage value of different polarizing units does not affected by each other, the shrinkage value of the entire structure of the polarizing layer is equally allocated to the plurality of independent polarizing units, so that the shrinkage value of the entire structure of the polarizing layer is divided into a plurality of portions and the shrinkage value of each of the polarizing units is small. In the case that the polarizer is applied into a display panel, the edge of each of the polarizing units can correspond to the black matrix region of one of the pixel units, so that when the polarizing units shrink, each of the polarizing units cannot leave from the black matrix region of the one of the pixel units into the display region of the one of the pixel units, and thus the normal display of the display panel cannot be adversely affected.

The above-mentioned embodiments are described by taking the case that the polarizer is a linear polarizer as an example, however, the polarizer provided by the embodiments of the present disclosure is not limited to be the linear polarizer, and also can be a circular polarizer, an elliptical polarizer, and the like, and no limitations will be given in the embodiments of the present disclosure in this respect.

The polarizer provided by the embodiments of the present disclosure can be applied into any display panels with a polarizer, such as a liquid crystal display panel, an OLED display panel, and the like. For example, in the case that the polarizer provided by at least one embodiment of the present disclosure is applied into a liquid crystal display panel, the shrinkage value of the polarizing units 3 at the bezel of the liquid crystal display panel can be significantly reduced, and therefore the bezel of the liquid crystal display panel can be manufactured into a narrow bezel with width being less than 2 mm.

In the case that the polarizer provided by at least one embodiment of the disclosure is applied into a display panel, because of a possible presence of cut errors in cutting the polarizing layer, it can be considered that the width of the polarizing unit is n time or times the width of the pixel unit and the length of the polarizing unit is m time or times the length of the pixel unit, in the present disclosure, as long as the edge of the polarizing unit is for example, within the black matrix region of one of the pixel units covered by the above-mentioned polarizing unit.

In the present embodiment, the black matrix region, which is provided between adjacent pixel units in the display panel and is shared by the adjacent pixel units, can be reasonably allocated to the adjacent pixel units, and the black matrix region can be shared equally or unequally by the adjacent pixel units. For example, the allocation of the black matrix region can be determined according to the position of the edge of a corresponding polarizing unit covering the black matrix region.

The following statements should be noted:

(1) The accompanying drawings involve only the structure(s) in connection with the embodiment(s) of the present disclosure, and other structure(s) can be referred to common design(s).

(2) For the purpose of clarity, in accompanying drawings for illustrating the embodiment(s) of the present disclosure, the thickness and size of a layer or a structure may be enlarged, that is, the accompanying drawings are not drawn to scale. It should understood that, in the case in which a component or element such as a layer, film, area, substrate or the like is referred to be “on” or “under” another component or element, it may be directly on or under the another component or element or a component or element is interposed therebetween.

(3) In case of no conflict, the embodiments of present disclosure and features in the embodiments can be combined so as to obtain new embodiments.

What are described above is related to the illustrative embodiments of the disclosure only and not limitative to the scope of the disclosure; the scopes of the disclosure are defined by the accompanying claims.

The application claims priority to the Chinese patent application No. 201710333743.4, filed on May 12, 2017, the entire disclosure of which is incorporated herein by reference as part of the present application.

1. A polarizer, comprising:
a polarizing layer which comprises a plurality of independent polarizing units.

2. The polarizer according to claim 1, wherein
the polarizer is applied into a display panel, and the display panel comprises a plurality of pixel units; and
a length of each of the polarizing units is m time or times a length of each of the pixel units, and a width of the each of the polarizing units is n time or times a width of the each of the pixel units, wherein both m and n are positive integers, and both m and n are not more than 15.

3. The polarizer according to claim 1, wherein
the polarizer is applied into a display panel, and the display panel comprises a plurality of pixel units;
a length of each of the polarizing units is equal to a length of each of the pixel units, and a width of the each of the polarizing units is equal to a width of the each of the pixel units, and
the plurality of polarizing units are used to cover the plurality of pixel units in one-to-one correspondence.

4. The polarizer according to claim 1, wherein a width of each of the polarizing units is not greater than 500 μm and a length of each of the polarizing units is not greater than 1500 μm.

5. The polarizer according to claim 1, further comprising:
a protection layer, wherein the polarizing layer is arranged on a first surface of the protection layer.

6. The polarizer according to claim 5, further comprising:
a connection layer, provided on a second surface of the protection layer.

7. The polarizer according to claim 6, further comprising:
a release layer, provided on a surface, which is away from the protection layer, of the connection layer.

8. The polarizer according to claim 5, further comprising: an anti-scratch layer, provided on a surface, which is away from the protection layer, of the polarizing layer.

9. The polarizer according to claim 1, wherein a material of the polarizing layer is polyethylene.

10. The polarizer according to claim 5, wherein a material of the protection layer is cellulose triacetate.

11. The polarizer according to claim 8, further comprising a connection layer and a release layer, wherein a material of the connection layer is a pressure-sensitive adhesive, and the release layer is a release film, and the anti-scratch layer is an anti-scratch film.

12. A display panel, comprising:
a panel body, and
the polarizer according to claim 1, wherein the polarizer is provided on a first panel surface of the panel body.

13. The display panel according to claim 12, wherein an edge of each of the polarizing units is corresponds to an outer edge of a black matrix region of a pixel unit, which is covered by the each of the polarizing units, of the panel body.

14. The display panel according to claim 12, wherein the display panel comprises a plurality of pixel units, and each of the polarizing units covers more than one pixel unit.

15. The display panel according to claim 12, wherein
the display panel comprises a plurality of pixel units;
the plurality of polarizing units cover the plurality of pixel units in one-to-one correspondence; and
edges of the plurality of polarizing units are located at outer edges of the black matrix regions of the plurality of pixel units in one-to-one correspondence.

16. A display device, comprising the display panel according to claim 12.

17. A preparation method of a polarizer, comprising: cutting a polarizing layer to form a plurality of independent polarizing units.

18. The preparation method of the polarizer according to claim 17, wherein
the polarizer is applied into a display panel, and the display panel comprises a plurality of pixel units; and
a length of each of the polarizing units is m time or times a length of each of the pixel units, and a width of the each of the polarizing units is n time or times a width of the each of the pixel units, wherein both m and n are positive integers, and both m and n are not more than 15.

19. The preparation method of the polarizer according to claim 17, wherein the polarizing layer is formed on a protection layer, and then the plurality of independent polarizing units are formed by cutting the polarizing layer formed on the protection layer.

20. The preparation method of the polarizer according to claim 17, wherein the polarizing units are in one-to-one correspondence with the plurality of pixel units.
